(19) United States
(12) Patent Application Publication
(10) Pub. No.: US 2012/0300616 A1
(43) Pub. Date: Nov. 29, 2012

(54) Methods and Apparatuses for Resource Mapping for Multiple Transport Blocks Over Wireless Backhaul Link

(75) Inventors: Erlin Zeng, Beijing (CN); Haiming Wang, Beijing (CN); Jing Han, Beijing (CN)

(73) Assignee: NOKIA CORPORATION, Espoo (FI)

(21) Appl. No.: 13/576,376

(22) PCT Filed: Feb. 2, 2010
(86) PCT No.: PCT/CN2010/070470

§ 371 Date: Jul. 31, 2012

(51) Int. Cl. H04W 72/04

(52) U.S. Cl. 370/216; 370/329; 370/315

(57) ABSTRACT

In accordance with an example embodiment of the present invention, a method comprises scheduling at a wireless network node one or more resources for an uplink backhaul link of a relay node; and applying a mapping scheme to map at least one buffer content to at least one transport block, wherein the mapping scheme comprises determining a transport block index indicator to identify a mapping between the buffer content and the transport block; inserting the transport block index indicator into a resource grant; and transmitting the resource grant to the relay node on a downlink control channel.

### TECHNICAL FIELD

The present application relates generally to method and apparatuses for resource mapping for multiple transport blocks over wireless backhaul link.

### BACKGROUND

To help achieve extended network coverage, improve service quality, and provide services such as wireless broadcast TV on user equipments, wireless relay links are being developed for a new generation of network technologies such as 4^{th} generation (4G) wireless networks. A wireless relay link is a wireless connection between a radio access node and a relay node so that the access node may be coupled to an end user device or user equipment via the relay node. Otherwise the user equipment may be out of the reach of the access node or receive a poor-quality service from the access node.

Control signaling is a part of a wireless relay link because it enables communications between the access node and the relay node. The access node may send control instructions such as a resource grant, a transmission acknowledgement, and a negative transmission acknowledgement, among others, to the relay node via the control signaling. With the control signaling, a connection may be set up between the access node and the relay node, resource may be scheduled and allocated, a transmission error between the two may be detected and corrected. The control signaling may take place at any one of the layers of open system interconnection (OSI) network model, including the physical layer, also termed layer 1, the data link and radio link control layer, also termed layer 2, and the network layer, also termed layer 3.

A wireless downlink backhaul is a link from the access node, also referred to as donor node to the relay node. One difference between a backhaul link and a regular link is that the data traffic for multiple UEs on the backhaul link is aggregated to improve the transmission efficiency and capacity. Data traffic of different Quality of Service (QoS) types may be bundled over the backhaul link to form a transport block (TB). The physical layer of the existing standard such as LTE Release 8 (Rel. 8) may handle the transport blocks with one relay-physical downlink control channel (R-PDCCH) for granting the resources, and one uplink channel for acknowledgement (ACK) and negative acknowledgment (NACK) feedback.

### SUMMARY

Various aspects of examples of the invention are set out in the claims.

According to a first aspect of the present invention, a method comprises scheduling at a wireless network node one or more resources for an uplink backhaul link of a relay node; and applying a mapping scheme to map at least one buffer content to at least one transport block, wherein the mapping scheme comprises determining a transport block index indicator to identify a mapping between the buffer content and the transport block; inserting the transport block index indicator into a resource grant; and transmitting the resource grant to the relay node on a downlink control channel.

According to a second aspect of the present invention, an apparatus a resource module configured to schedule one or more resources for an uplink backhaul link of a relay node; a mapping module configured to apply a mapping scheme to map at least one buffer content to at least one transport block, wherein the mapping scheme includes at least one of determining a transport block index indicator to identify a mapping between the buffer content and the transport block; and inserting the transport block index indicator into a resource grant; and an interface module configured to transmit the resource grant to the relay node on a downlink control channel.

According to a third aspect of the present invention, an apparatus comprises at least one processor; and at least one memory including computer program code the at least one memory and the computer program code configured to, with the at least one processor, cause the apparatus to perform at least the following: detecting a uplink resource grant in a received control message on a physical downlink control channel; checking a transport block index indicator in the uplink resource grant that indicates a mapping between a buffer content and a transport block; and mapping the buffer content to a scheduled transport block based on the transport block index indicator.

### BRIEF DESCRIPTION OF THE DRAWINGS

In some current standards specification, such as Long Term Evolution (LTE) Release-8, data traffic of different QoS types are bundled over a backhaul link to form a transport block (TB), and the traffic of the different QoS types are treated indiscriminately in terms of scheduling and HARQ operations. There is a need for a control signaling design for backhaul links to enable a resource mapping between transport blocks and buffer contents over backhaul uplinks. A new signaling filed, a transport block index indicator, is introduced to enable the relay node to map the data of different QoS types into proper resources allocated at an access node.

For a more complete understanding of example embodiments of the present invention, reference is now made to the following descriptions taken in connection with the accompanying drawings in which:

FIG. 1 illustrates an example wireless relay system in accordance with an example embodiment of the invention.

FIG. 2 illustrates an example method 200 for mapping between a buffer content and a transport block in accordance with an example embodiment of the invention;

FIG. 3 illustrates an example mapping rule in accordance with an example embodiment of the invention;

FIG. 4 illustrates an example mapping with a predefined rule in accordance with an example embodiment of the invention;

FIG. 5 illustrates an example downlink transport block retransmission scheme in accordance with an example embodiment of the invention;

FIG. 6 illustrates an example apparatus for implementing the mapping between a buffer content and a transport block in accordance with an example embodiment of the invention;

FIG. 7 illustrates an example method for carrying out the mapping at a relay node based on a transport block index indicator in accordance with an example embodiment of the invention; and

FIG. 8 illustrates an example wireless apparatus in accordance with an example embodiment of the invention.

### DETAILED DESCRIPTION OF THE DRAWINGS

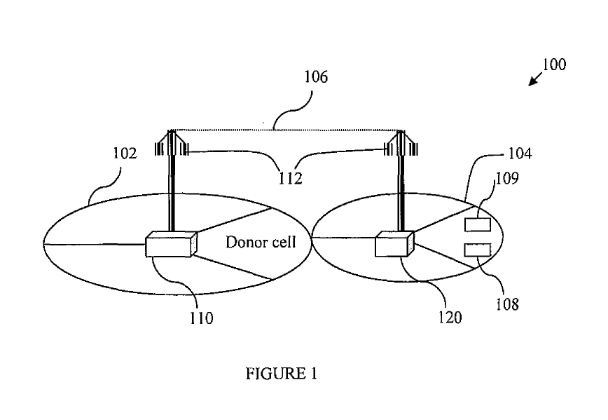

An example embodiment of the present invention and its potential advantages are understood by referring to FIGS. 1 through 8 of the drawings.

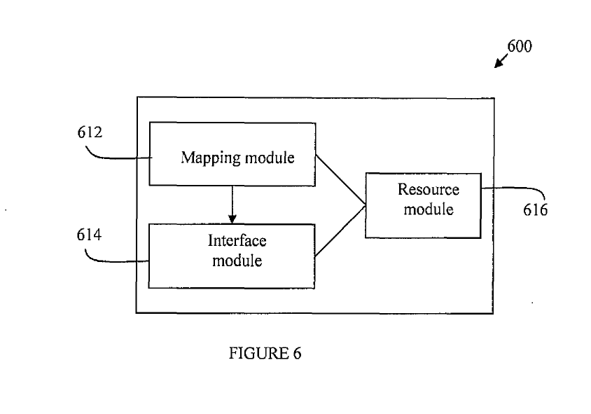

FIG. 1 illustrates an example wireless relay system 100 in accordance with an example embodiment of the invention. In one example embodiment, the example wireless relay system 100 includes one wireless access node 110 and a relay node 120. The wireless access node 110 is located in a wireless cell 102 and is coupled to a transmission tower 112. The cell 102, or at least part of the cell 102 is also referred to as a donor cell because it is through this cell that communications are extended to the user equipments associated with the relay node 120. The relay node 120 is located in an adjacent relay cell 104 and coupled to another transmission tower 112. The wireless access node 110 may include a relay mapping apparatus and communicate with the relay node 120 via a backhaul link 106. In a way, the wireless relay node 120 may be viewed as an extension to the access node 110 to reach end user equipments 108 and 109. More details of the access node 110 are illustrated in FIG. 6 and described hereinafter. More details of the relay node 120 are illustrated in FIG. 800 and described hereinafter.

In one example embodiment, the control signaling between the access node 110 and the relay node 120 may be carried on the wireless relay link 106 and may be either an inband control signaling or outband control signaling. An inband signaling is carried on a wireless link between the two nodes using the same frequency band. An outband signaling may use a relay link that uses a frequency band different from that of the access node 110. The outband resources with a powerful amplifier for the eNodeB relay link may make the backhaul link an add-on to eNodeB.

In one example embodiment, the access node 110 has data of two different quality of service (QoS) types to be sent from the UEs 108 and 109 to the access node 110 via the relay node 120. One QoS type of data is for a web browsing session on the UE 108 and the other QoS type of data is for a voice call on the UE 109. The wireless access node 110 may first reserve the backhaul link resources for the data transmission and sends a resource grant to the relay node 120. Included in the resource grant is a transport block index indicator that indicates to the relay node 120 how to map the user data to a particular transport block so the different QoS types of user data may be treated differently. For example, the more time-sensitive voice call on the UE 109 may be given a higher priority over web browsing session on the UE 108 in resource scheduling and hybrid automatic repeat request (HARQ) operations.

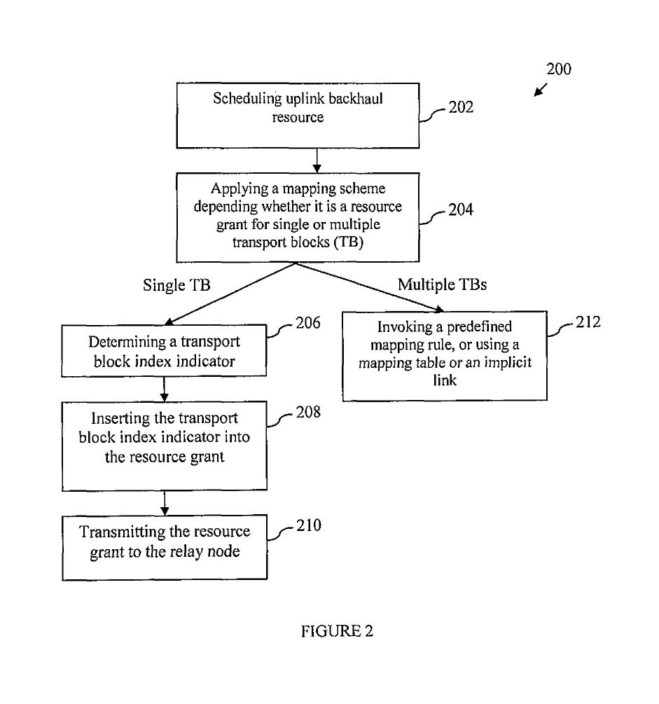

FIG. 2 illustrates an example method 200 for mapping between a buffer content of user data and a transport block in accordance with an example embodiment of the invention. The example mapping method 200 includes scheduling uplink backhaul resources at block 202, and applying a mapping scheme depending whether a resource grant is for a single or multiple transport blocks at block 204. If the grant is used to schedule a single transport block, the mapping schedule of the method 200 includes determining a transport block index indicator at block 206, inserting the transport block indicator into the resource grant at block 208 and transmitting the resource grant to the relay node at block 210. The method 200 also includes invoking a predefined mapping rule, or using a mapping table or an implicit link at block 212 if the resource grant is used to schedule multiple transport blocks.

In one example embodiment, scheduling uplink backhaul resource at block 202 may include allocating and reserving transport blocks on an uplink transport channel for a relay node to transport user data. Scheduling uplink backhaul resource at block 202 may also include creating a resource grant of a downlink control message to specify the physical resources and the associated transport blocks for the resource allocation.

In one example embodiment, applying the mapping scheme at block 204 may include determining whether a resource grant is used to schedule multiple resources or a single resource. If the resource grant is used to schedule a single resource, the method 200 may proceed to determining a transport block index indicator at block 206. As in some current or future embodiments, if one resource grant is used for multiple physical resources, the method 200 may proceed to invoking a predefined rule, using a mapping table or an implicit link at block 212.

In one example embodiment, determining a transport block index indicator at block 206 may include determining a mapping between a data buffer holding user data and an allocated transport block so that the relay node knows where the content of user data buffer goes. The mapping may be based on a variety of criteria and one example criterion is quality of service (QoS). For example, data of different QoS types may be mapped to different transport blocks. Thus the data from different UEs with different QoS types may be distinguished for different treatment at both the relay node 120 and the wireless access node 110 of FIG. 1. Determining the transport block index indicator at block 206 may also include determining a size of the transport block index indicator because the number of transport blocks in a subframe to be allocated may vary from one allocation to another. The size may be decided by the function ceil(log₂(N)) bits where N is a maximum number of transport blocks in one transmission time interval over a backhaul link.

In one example embodiment, inserting the transport block indicator into the resource grant at block 208 may include creating a new field for the transport block index indicator in the resource grant of a down link control signaling message. For an example implementation, inserting the transport block index indicator includes inserting the index indicator into a downlink control information (DCI) field. Transmitting the resource grant at block 210 may include transmitting the downlink control message using a scheduled resource.

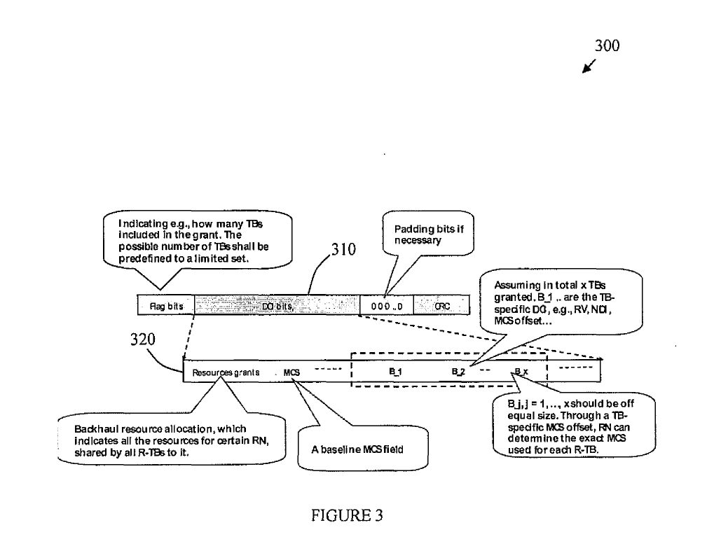

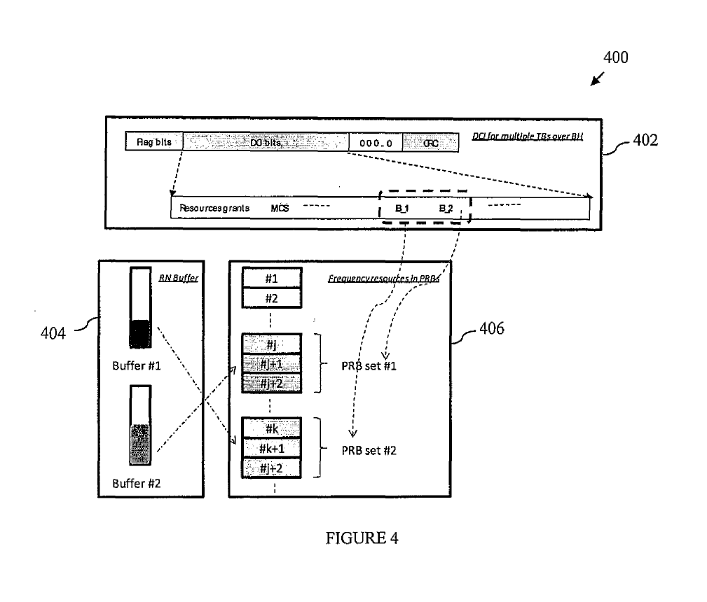

In one example embodiment, the resource grant is used to schedule multiple transport blocks. Thus, the method 200 includes using one of three alternative methods for mapping transport blocks to buffer contents. In one example embodiment, invoking a predefined mapping rule at block 212 may include using a predefined mapping rule at both ends of backhaul link. A mapping rule may be predefined so that the relay node can determine proper data mapping of different transport blocks. In one example embodiment, one predefined mapping rule is for the network access node 110 of FIG. 1 to arrange one or more TB-specific fields in a descending or ascending order in TB index. With such a rule, the relay node 120 can determine the data buffer from which the data is mapped to the transport block resources. FIG. 3 and FIG. 4 illustrate more details of an example mapping rule.

In one example embodiment, using a mapping table at block 212 may include a table lookup to find a mapping between a content buffer and a transport block. The mapping table may be created on demand, statically offline or semi-dynamically and the mapping table created at the wireless access node is communicated to the relay node so both sides of the backhaul link can perform the same mapping. In one example embodiment, the mapping table may be indexed by the transport block index. Thus, using a transport block index, the relay node may map data in a content buffer to a transport block and the network access node may retrieve the data based on the transport block index at the other end of the backhaul link.

In one example embodiment, using an implicit link at block 212 may include defining an implicit linkage between uplink resources that are allocated to different transport blocks and user data buffer contents. For example, a relationship between a physical resource block (PRB) index and a buffer content index may be defined so that relay node can determine correct buffer for data mapping by a starting point of PRB sets. One example for such linkage is that the data with lower TB index are mapped to the PRB set which starts from a PRB with a larger index.

In one example embodiment, the method 200 may be implemented in the access node 110 of FIG. 1 or by the apparatus 600 of FIG. 6. The method 200 is for illustration only and the steps of the method 200 may be combined, divided, or executed in a different order than illustrated, without departing from the scope of the invention of this example embodiment.

FIG. 3 illustrates an example mapping rule 300 for mapping between transport blocks and buffer contents. The example mapping rule 300 includes a downlink control channel 310 that in turn includes a downlink control information (DCI) field 320 for multiple uplink transport block grants. The downlink control channel 310 includes a flag field, a DCI field, a padding field and a cyclic redundancy check (CRC) field. The flag field is used to indicate a number of transport blocks included in a resource grant. The DCI field 320 may include multiple resource grants, a modulation coding scheme (MCS) field for each of transport blocks, and transport block indices B_1, B_2, . . . , B_x. In one embodiment, one simple mapping rule is for the access node to arrange the TB-specific fields such as transport block indices in a data order such as a descending (or ascending) order. With such a rule, the relay node can determine a mapping from buffer contents to the allocated transport blocks.

FIG. 4 illustrates another example mapping 400 with a predefined rule in accordance with an example embodiment of the invention. In one example embodiment, the example mapping 400 includes a downlink control channel information block 402, a set of content buffers 404 and a set of physical resource blocks 406. The relay node has two content buffers for two transport blocks at 404, while buffer #1 maps to the transport block #1, and buffer #2 maps to the transport block #2. In one example embodiment, the relay node has the knowledge that that the TB-specific index field B_1 refers to a PRB set #2 while the index field B_2 refers to a PRB set #1. Based on the predefined rule, the relay node can determine that the PRB set #2 is for transport block #1 and thus the relay node maps the data in Buffer #1 to the PRB set #2. Similarly data in Buffer #2 is mapped to the PRB set #1.

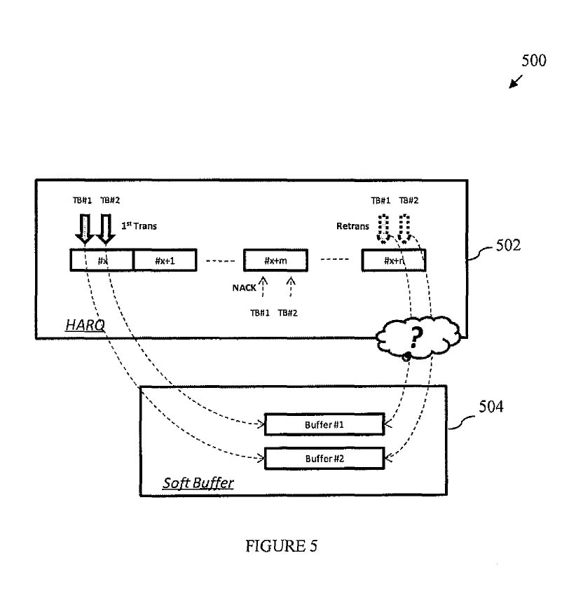

FIG. 5 illustrates an example downlink transport block retransmission scheme 500 in accordance with an example embodiment of the invention. In one example embodiment, the retransmission scheme 500 includes a subframe set 502 with a number of scheduled transport blocks and a content buffer set 504. In one embodiment, the network access node such as a donor node eNodeB 110 of FIG. 1 may schedule two transport blocks in the subframe #x and receive a negative acknowledgement (NACK) for both transport blocks in subframe #x+m where m may be set according to the HARQ setting of the backhaul link. The network access node may schedule retransmissions of the two transport blocks in the subframe #x+n. Upon receiving the retransmitted transport blocks, the relay node may combine the retransmitted transport blocks with their respective first transmissions. In order for the relay node to properly combine the retransmitted transport blocks with the respective first transmission, the relay node need to know the content buffer index for each scheduled transport block. In one embodiment, a transport block index indicator is inserted in a downlink grant, for both the first transmission and the retransmission of the transport block so the relay node can map the retransmitted transport block to the first transmission of the transport block. In another embodiment, an implicit linkage between the transport block indices and frequency resources for the scheduled transport blocks is used to link the retransmitted transport block to the first transmission of the transport block.

FIG. 6 illustrates an example apparatus 600 for implementing a mapping between a buffer content and a transport block in accordance with an example embodiment of the invention. The apparatus 600 includes a mapping module 612, an interface module 614, and a resource module 616.

In one example embodiment, the interface module 614 is configured to transmit a resource grant to the relay node on a downlink control channel. The resource module 616 is configured to allocate one or more resources for an uplink backhaul link of a relay node.

In one example embodiment, the mapping module 612 is configured to apply a mapping scheme depending whether the resource grant is used to schedule a transport block or multiple transport blocks. If it is for a single transport block, the mapping scheme may include determine a transport block index indicator to identify a mapping between a buffer content and a transport block and inserting the transport block index indicator into the resource grant by inserting the transport block index indicator into a downlink control information (DCI) field. The mapping module 612 is configured to determine the transport block index indicator by identifying the mapping between the transport block and the buffer content to distinguish data by different QoS types. The mapping module 612 is also configured to determine a size of the transport block index indicator by ceil(log₂(N)) bits where N is a maximum number of transport blocks in one transmission time interval over a backhaul link.

In one example embodiment, the mapping module 612 is further configured to perform at least one of following if the resource grant is used to schedule multiple transport blocks: predefining at least one mapping rule to map a plurality of buffer contents to a plurality of transport block and communicating the at least one mapping rule to the relay node; building a mapping table to map the plurality of buffer contents to the plurality of transport blocks; and creating implicit links between the plurality of buffer contents and the plurality of physical resource blocks. The mapping rule may be predefined based on data order such as an ascending QoS type or a descending QoS type of the plurality buffer contents; The mapping table entry may be created for a mapping between one of the buffer contents and one of the multiple transport blocks in one of a dynamic manner, a semi-dynamic manner and a static manner. The implicit link may be created by creating a relationship between a physical resource block index and a buffer content index. The mapping module 612 may also be configured to cause retransmission on a downlink channel of a transport block that includes the transport block index indicator to map the transport block to a previously transmitted transport block to enable the relay node to combine the two transport blocks during a HARQ operation at the relay node;

The apparatus 600 is at least part of an LTE eNodeB node, or a fourth generation wireless network access node. Although FIG. 6 illustrates one example of an apparatus 600, various changes may be made to the apparatus without departing from the principles of the invention.

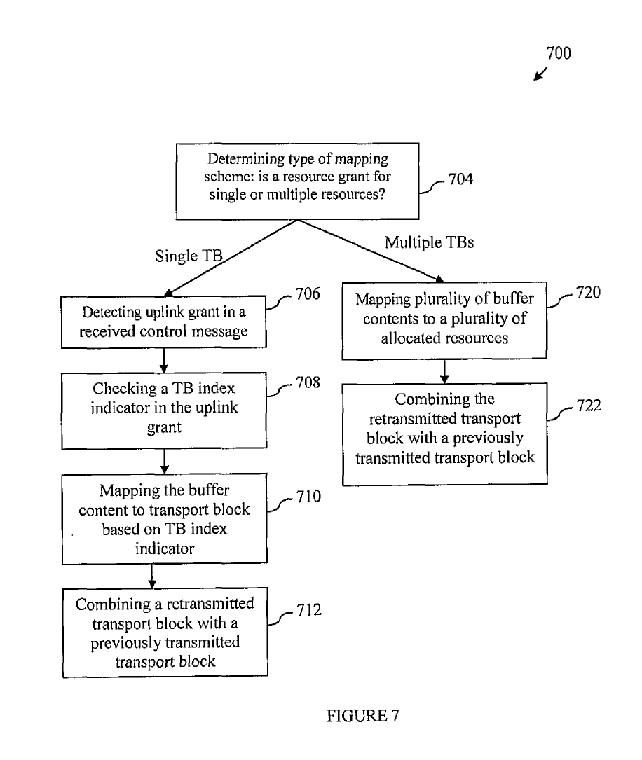

FIG. 7 illustrates an example method 700 for carrying out the mapping between a buffer content and a transport block based on a transport block index indicator in accordance with an example embodiment of the invention. The method 700 may include determining a type of mapping scheme at block 704, based on whether a resource grant is used to schedule a single or multiple transport blocks. If the resource grant is used to schedule a single transport block, the method 700 may include detecting an uplink resource grant in a received control message at 706 and checking a transport block index indicator in the uplink grant at block 708. The method 700 may further include mapping a buffer content to a transport block based on the transport block index indicator at block 710 and combining a retransmitted transport block with a previously transmitted transport block. If the resource grant is used to schedule multiple transport blocks, the method 700 may include mapping plurality of buffer contents to a plurality of allocated resources at 720 and combining the one or more retransmitted transport blocks with one or more previously transmitted transport blocks at block 722.

In one example embodiment, detecting an uplink resource grant in a received control message at 706 may include decoding a downlink control channel message including a resource grant sent from the network access node to the relay node and extracting the resource grant from a downlink control information field. In one example embodiment, checking a transport block index indicator in the extracted uplink resource grant at block 708 may include extracting the transport block index indicator from the extracted uplink resource grant. The size of the transport block index indicator may be included in the resource grant or computed using a function ceil(log₂(N)) bits where N is a maximum number of transport blocks in one transmission time interval over a backhaul link.

In one example embodiment, mapping the buffer content to a transport block based on the transport block index indicator at block 710 may include associating the buffer content with a transport block using the transport block index indicator and filling the transport block with the identified buffer content.

In one example embodiment, the transmission of the resource grant may fail and as a result, the relay node may receive a retransmission of the resource grant or data. Combining a retransmitted transport block with a previously transmitted transport block may include using the transport block index indicator from the first transmission to match the retransmitted transport block and combining the retransmitted transported block with the previously transmitted transport blocks within the same subframe.

In one example embodiment, the resource grant is used to schedule multiple transport blocks. In this case, the method 700 may include mapping plurality of buffer contents to a plurality of allocated resources at 720, using one of three alternative methods: one predefined rule, a mapping table, and an implicit link from the buffer content to a physical resource block. It is assumed that a prior agreement is reached between the network access node and the relay node regarding which method to use for mapping a buffer content to a physical resource block and the agreement may be effectuated statically or dynamically.

In one embodiment, a mapping rule may be predefined so relay node can determine proper data mapping of to different transport blocks. In one example embodiment, one predefined mapping rule is for the access node to arrange the TB-specific fields in a descending or ascending order in TB index. With such a rule, the relay node can determine how to map the data buffer content to the resources.

In one example embodiment, using a mapping table for mapping the plurality of buffer contents to plurality of transport blocks at block 720 may include a table lookup to find a mapping between a content buffer and a transport block. The mapping table may be created on demand, statically offline or semi-dynamically and the mapping table created at a wireless access node is communicated to the relay node so both sides of the backhaul link can perform the same mapping. In one example embodiment, the mapping table may be indexed by the transport block index. Thus, using a transport block index, the relay node may map data in a content buffer to a transport block and the access node may retrieve the data based on the transport block index at the other end.

In one example embodiment, using an implicit link for mapping the plurality of buffer contents to plurality of transport blocks at block 720 may include defining an implicit linkage between uplink resources that are allocated to different transport blocks and user data buffer contents. For example, a relationship between a physical resource block (PRB) index and a transport block index may be defined so that relay node can determine correct buffer for data mapping by a starting point of the PRB sets. One simplest example for such implicit link is that the data with a lower TB index is mapped to the PRB set which starts from a PRB with a larger index.

In one example embodiment, transport blocks transmitted on a downlink backhaul link may get lost and the receiving relay node may combine the retransmitted transport blocks with the previously transmitted transport blocks of the same subframe. Combining a retransmitted transport block with a previously transmitted transport block at block 722 may include decoding and extracting a transport block index indicator from the retransmitted transport block and mapping the retransmitted transport block to the previously transmitted transport block. In one embodiment, combining the retransmitted transport block at block 722 may include combining the retransmitted transport block with a previously transmitted transport block based on the predefined rules, the mapping table or the implicit links during the HARQ operations.

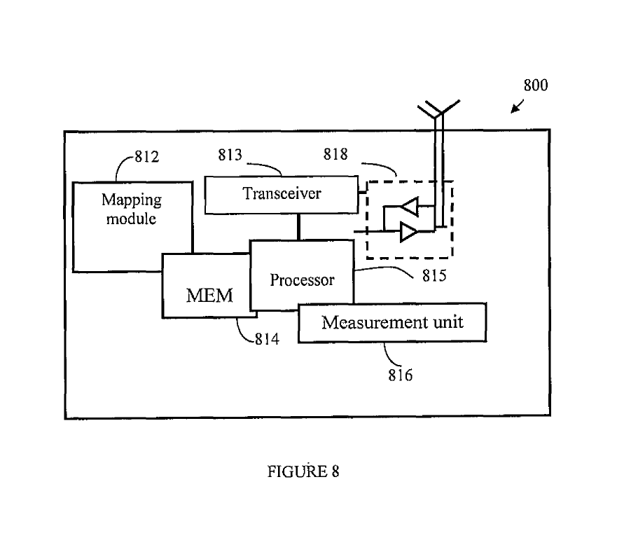

In one example embodiment, the method 700 may be implemented in the relay node 120 of FIG. 1 or in the apparatus 800 of FIG. 8. The method 700 is for illustration only and the steps of the method 700 may be combined, divided, or executed in a different order than illustrated, without departing from the scope of the invention of this example embodiment.

FIG. 8 is a block diagram illustrating an example wireless apparatus 800 including a mapping module in accordance with an example embodiment of the invention. In FIG. 8, the wireless apparatus 800 may include a processor 815, a memory 814 coupled to the processor 815, and a suitable transceiver 813 (having a transmitter (TX) and a receiver (RX)) coupled to the processor 815, coupled to an antenna unit 818. The memory 814 may store programs such as a resource mapping module 812.

In an example embodiment, the processor 815 or some other form of generic central processing unit (CPU) or special-purpose processor such as digital signal processor (DSP), may operate to control the various components of the wireless apparatus 800 in accordance with embedded software or firmware stored in memory 814 or stored in memory contained within the processor 815 itself. In addition to the embedded software or firmware, the processor 815 may execute other applications or application modules stored in the memory 814 or made available via wireless network communications. The application software may comprise a compiled set of machine-readable instructions that configures the processor 815 to provide the desired functionality, or the application software may be high-level software instructions to be processed by an interpreter or compiler to indirectly configure the processor 815. In an example embodiment, the mapping 812 may be configured to allocate one or more additional component carriers to a user equipment when a need arises and the resources are available in collaboration with other modules such as the transceiver 813.

In an example embodiment, the mapping module 812 may be configured to detect a uplink resource grant in a received control message on a physical downlink control channel, check a transport block index indicator in the uplink resource grant that indicates a mapping between a buffer content and a transport block and map the buffer content to a scheduled transport block based on the transport block index indicator. The mapping module 812 may be configured to map a plurality of buffer contents to a plurality of allocated transport blocks based on at least one of a set of predefined rules, a mapping table and implicitly links to associate transport block indices the physical resource block indices. The mapping module 812 may be configured to combine a retransmitted transport block with a previously transmitted transport block based on the transport block index indicator included in the retransmitted transport block during a hybrid automatic repeat request (HARQ) operation. The mapping module 812 may be configured to combine the retransmitted transport block with a previously transmitted transport block based on the predefined rules, the mapping table or the implicit links during the HARQ operation.

In one example embodiment, the transceiver 813 is for bidirectional wireless communications with another wireless device. The transceiver 813 may provide frequency shifting, converting received RF signals to baseband and converting baseband transmit signals to RF, for example. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. In some embodiments, the transceiver 813, portions of the antenna unit 818, and an analog baseband processing unit may be combined in one or more processing units and/or application specific integrated circuits (ASICs). Parts of the transceiver may be implemented in a field-programmable gate array (FPGA) or reprogrammable software-defined radio.

In one example embodiment, the transceiver 813 may include a filtering apparatus for non-centered component carriers such as the filtering apparatus 300. As such, the filtering apparatus may include a processor of its own and at least one memory including computer program code. The at least one memory and the computer program code configured to, with the processor, cause the filtering apparatus to perform at least the following: converting a first frequency signal into a second frequency signal based at least in part on a first complex-valued local oscillator signal; filtering the second frequency signal; and converting the filtered second frequency signal into a third frequency signal based at least in part on a second complex-valued local oscillator signal wherein the third frequency signal shares a frequency position with the first frequency signal and the first complex-valued local oscillator signal and the second complex-valued local oscillator signal indicate allocations of transmitted channels.

In an example embodiment, the antenna unit 818 may be provided to convert between wireless signals and electrical signals, enabling the wireless apparatus 800 to send and receive information from a cellular network or some other available wireless communications network or from a peer wireless device. In an embodiment, the antenna unit 818 may include multiple antennas to support beam forming and/or multiple input multiple output (MIMO) operations. As is known to those skilled in the art, MIMO operations may provide spatial diversity and multiple parallel channels which can be used to overcome difficult channel conditions and/or increase channel throughput. The antenna unit 818 may include antenna tuning and/or impedance matching components, RF power amplifiers, and/or low noise amplifiers.

As shown in FIG. 8, the wireless apparatus 800 may further include a measurement unit 816, which measures the signal strength level that is received from another wireless device, and compare the measurements with a configured threshold. The measurement unit may be utilized by the wireless apparatus 800 in conjunction with various exemplary embodiments of the invention, as described herein.

In general, the various exemplary embodiments of the wireless apparatus 800 may include, but are not limited to, part of a user equipment, or a wireless device such as a portable computer having wireless communication capabilities, Internet appliances permitting wireless Internet access and browsing, as well as portable units or terminals that incorporate combinations of such functions.

Without in any way limiting the scope, interpretation, or application of the claims appearing below, a technical effect of one or more of the example embodiments disclosed herein is to map a transport block to a buffer content of use data to support differential treatments of the user data of different QoS types.

Embodiments of the present invention may be implemented in software, hardware, application logic or a combination of software, hardware and application logic. The software, application logic and/or hardware may reside on a base station or an access point. If desired, part of the software, application logic and/or hardware may reside on access point, part of the software, application logic and/or hardware may reside on a network element such as a LTE eNodeB and part of the software, application logic and/or hardware may reside on relay node. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 8. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-27. (canceled)

28. A method, comprising:
scheduling at a wireless network node one or more resources for an uplink backhaul link of a relay node; and
applying a mapping scheme to map at least one buffer content to at least one transport block, wherein the mapping scheme comprises at least one of:
determining a transport block index indicator to identify a mapping between the buffer content and the transport block;
inserting the transport block index indicator into a resource grant; and
transmitting the resource grant to the relay node on a downlink control channel.

29. The method of claim 28 wherein scheduling the one or more resources for the uplink backhaul link of the relay node further comprises allocating at least one physical resource block and one or more associated transport blocks.

30. The method of claim 28 wherein determining the transport block index indicator further comprises determining a size of the transport block index indicator via a function ceil(log₂(N)) where N is a maximum number of transport blocks in one transmission time interval over a backhaul link.

31. The method of claim 28 wherein determining the transport block index indicator further comprises identifying the mapping between the transport block and the buffer content to distinguish user data of different quality of service (QoS) types.

32. The method of claim 28 wherein inserting the transport block index indicator into the resource grant comprises inserting the transport block index indicator into a downlink control information (DCI) field of the downlink control channel.

33. The method of claim 28, wherein if the resource grant is used to schedule multiple transport blocks, the mapping scheme comprises at least one of:
invoking at least one predefined mapping rule to map a plurality of buffer contents to a plurality of transport blocks;
looking up at least one entry in a mapping table to map one of the plurality of buffer contents to one of the plurality of transport blocks; and
using at least one implicit link to map one of the plurality of buffer contents to the plurality of physical resource blocks.

34. The method of claim 33 wherein the at least one mapping rule is based on a data order that includes at least one of an ascending QoS type and a descending QoS type of the plurality of buffer contents.

35. The method of claim 33 wherein the mapping table including at least one association between a buffer content and a transport block index is defined in one of a dynamic manner, a semi-dynamic manner and a static manner.

36. The method of claim 33 wherein the at least one implicit link further comprises a relationship between a physical resource block index and a buffer content index.

37. An apparatus, comprising:
at least one processor; and
at least one memory including computer program code
the at least one memory and the computer program code configured to, with the at least one processor, to cause the apparatus at least to:
schedule at a wireless network node one or more resources for an uplink backhaul link of a relay node; and
apply a mapping scheme to map at least one buffer content to at least one transport block, wherein the mapping scheme comprises at least one of:
determine a transport block index indicator to identify a mapping between the buffer content and the transport block;
insert the transport block index indicator into a resource grant; and
transmit the resource grant to the relay node.

38. The apparatus of claim 37 wherein the at least one memory and computer program code are further configured, with the at least one processor, when schedule the one or more resources for the uplink backhaul link of the relay node, to cause the apparatus at least to allocate at least one physical resource block and one or more associated transport blocks.

39. The apparatus of claim 37 wherein determine the transport block index indicator further comprises determine a size of the transport block index indicator via a function ceil(log₂(N)) where N is a maximum number of transport blocks in one transmission time interval over a backhaul link.

40. The apparatus of claim 37 wherein determine the transport block index indicator further comprises identify the mapping between the transport block and the buffer content to distinguish user data of different quality of service (QoS) types.

41. The apparatus of claim 37 wherein insert the transport block index indicator into the resource grant comprises insert the transport block index indicator into a downlink control information (DCI) field of the downlink control channel.

42. The apparatus of claim 37, wherein if the resource grant is used to schedule multiple transport blocks, the mapping scheme comprises at least one of:
invoke at least one predefined mapping rule to map a plurality of buffer contents to a plurality of transport blocks;
look up at least one entry in a mapping table to map one of the plurality of buffer contents to one of the plurality of transport blocks; and
use at least one implicit link to map one of the plurality of buffer contents to the plurality of physical resource blocks.

43. The apparatus of claim 42 wherein the at least one predefined mapping rule is based on a data order that includes at least one of an ascending QoS type and a descending QoS type of the plurality of buffer contents.

44. The apparatus of claim 42 wherein the mapping table including at least one association between a buffer content and a transport block index is defined in one of a dynamic manner, a semi-dynamic manner and a static manner.

45. The apparatus of claim 42 wherein the at least one implicit link further comprises a relationship between a physical resource block index and a buffer content index.

46. The apparatus of claim 37, wherein the at least one memory and computer program code are further configured, with the at least one processor, to cause the apparatus at least to retransmit on a second downlink control channel a transport block that includes the transport block index indicator to map the transport block to a previously transmitted transport block to enable the relay node to combine the two transport blocks during a hybrid automatic repeat request (HARQ) operation.

47. An apparatus, comprising
at least one processor; and
at least one memory including computer program code
the at least one memory and the computer program code configured to, with the at least one processor, to cause the apparatus at least to:
detect a uplink resource grant in a received control message on a physical downlink control channel;
check a transport block index indicator in the uplink resource grant that indicates a mapping between a buffer content and a transport block; and
map the buffer content to a scheduled transport block based on the transport block index indicator.

48. The apparatus of claim 47 wherein the at least one memory and the computer program code is further configured to, with the at least one processor, cause the apparatus to at least to:
map a plurality of buffer contents to a plurality of allocated transport blocks based on at least one of predefined rules, a mapping table and implicitly links to map transport block indices to physical resource block indices;
combine a retransmitted transport block with a previously transmitted transport block based on the transport block index indicator included in the retransmitted transport block during a hybrid automatic repeat request (HARQ) operation; and
combine the retransmitted transport block with a previously transmitted transport block based on the predefined rules, the mapping table or the implicit links during the HARQ operation.

49. The apparatus of claim 47 wherein the apparatus is at least part of a relay node or a terminal of fourth generation wireless network.
